(19) United States
(12) Patent Application Publication
(10) Pub. No.: US 2008/0129775 A1
(43) Pub. Date: Jun. 5, 2008

(54) Image recording apparatus and controlling method thereof

(75) Inventor: Kiyoharu Hayakawa, Nagoya-shi (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Brother Kogyo Kabushiki Kaisha

(21) Appl. No.: 11/999,442

(22) Filed: Dec. 4, 2007

(30) Foreign Application Priority Data
Dec. 4, 2006 (JP) 2006-326502

(51) Int. Cl. B41J 2/15

(52) U.S. Cl. 347/23

(57) ABSTRACT

When receiving a command to record an image on a recording medium, controlling means causes recovering means to execute a recovery operation, and then recording means to execute image recording when an elapsed time from the execution of a previous recovery operation measured by clocking means exceeds a predetermined time and a coverage rate of a recording part calculated by coverage rate calculating means exceeds a predetermined value. The controlling means causes the recording means to execute image recording without causing the recovering means to execute the recovery operation when the coverage rate of the recording part calculated by the coverage rate calculating means is not more than the predetermined value.

### CROSS-REFERENCE TO RELATED APPLICATIONS

The present application claims priority under 35 U.S.C. §119(a) on Patent Application No. 2006-326502 filed in Japan on Dec. 4.2006, the entire contents of which are hereby incorporated by reference.

### TECHNICAL FIELD

The present invention relates to an image recording apparatus including recording means for ejecting ink from a nozzle to a recording medium and a method for controlling the image recording apparatus.

### BACKGROUND

There is an ink-jet printer for recording data by ejecting ink from a nozzle, or a multifunctional type printer including a copy function, facsimile function, a scanner function and the like, and conventionally these printers are provided with recovering means for improving an ejecting condition of the nozzle.

The recovering means includes a pump and the like to forcibly eject ink in a recording head to the outside to remove thick ink, dry ink, bubble and the like, and a wiper to wipe away ink attached on a nozzle surface of the recording head. In addition, the recovering means drives the recording head regardless of a recording operation to forcibly eject the ink in the recording head to the outside, to keep the ejecting condition of the ink preferable. In general, an elapsed time from a previous recovery operation is measured and when the elapsed time exceeds a predetermined time at the time of the recording operation, the recovery operation is automatically executed. Needless to say, when a user requests the recovery operation, the user can give a command for the recovery operation by operating a button and the like regardless of the elapsed time.

In addition, Japanese Patent Application Laid-Open No. 2005-238710 discloses a constitution in which in order to shorten a time from when a document is read until the recording operation is completed, an operation to be performed by a user prior to reading the document is regarded as an operation to be performed before the recording operation is commanded, and in a case where a recovery operation is needed, the recovery operation is performed before the recording operation is commanded. More specifically, the recovery operation is performed when a cover of a document table on which a document is set is opened, or when the size of a recording medium or the recording number is set, or when the document is set in an automatic document feeder (ADF).

### SUMMARY

According to the recovering means for performing the recovery operation depending on the elapsed time from the previous recovery operation, when a user gives a command of recording an image to a recording medium, the recovery operation is executed prior to the recording operation in a case where a predetermined time has passed from the previous recovery operation. Thus, it takes a lot of time for the recording operation to be completed in some cases. In addition, the recovery operation is always executed after the predetermined time has passed regardless of the condition of the recording operation.

The inventors have found that sufficiently preferable recording can be performed without the recovery operation even when the predetermined time has passed, depending on a coverage rate of a recording part in the recording image.

Thus, in order to solve the above problems, it is an object to reduce the number of recovery operations before the recording operation is performed and prevent ink from being wasted due to the recovery operation.

In order to attain the above object, an image recording apparatus according to a first aspect is characterized by an image recording apparatus comprising: a recording unit ejecting ink from a nozzle to a recording medium to record an image; a recovery unit performing a recovery operation to recover an ejecting condition of said nozzle; a clocking unit measuring an elapsed time from a previous recovery operation by said recovery unit; a receiving unit receiving a command to record the image on the recording medium, and a controller capable of: calculating a coverage rate of a recording part of the image to be recorded by said recording unit; comparing said elapsed time with a first predetermined time; comparing said coverage rate of the recording part with a predetermined value; and causing said recovery unit to execute the recovery operation and then said recording unit to execute the image recording in a case where said elapsed time exceeds said first predetermined time and said coverage rate of the recording part exceeds said predetermined value, and causing said recording unit to execute the image recording without causing said recovery unit to execute the recovery operation in a case where said coverage rate of the recording part is not more than said predetermined value, when said receiving unit receives said command.

An image recording apparatus according to a second aspect is characterized by an image recording apparatus comprising: recording means for ejecting ink from a nozzle to a recording medium to record an image; recovering means for performing a recovery operation to recover an ejecting condition of said nozzle; clocking means for measuring an elapsed time from a previous recovery operation by said recovery unit; receiving means for receiving a command to record the image on the recording medium; coverage rate calculating means for calculating a coverage rate of a recording part of the image to be recorded by said recording means; comparing means for comparing said elapsed time with a first predetermined time; comparing means for comparing said coverage rate of the recording part with a predetermined value; and controlling means for causing said recovering means to execute the recovery operation and then said recording means to execute the image recording in a case where said elapsed time exceeds said first predetermined time and said coverage rate of the recording part exceeds said predetermined value, and causing said recording means to execute the image recording without causing said recovering means to execute the recovery operation in a case where said coverage rate of the recording part is not more than said predetermined value, when the receiving means receives the command.

An image recording apparatus according to a third aspect is characterized by a method of controlling an image recording apparatus comprising a recording unit ejecting ink from a nozzle to a recording medium to record an image, a recovery unit performing a recovery operation to recover an ejecting condition of said nozzle, a clocking unit measuring an elapsed time from a precious recovery operation by said the recovery unit, and a receiving unit receiving a command to record the image on the recording medium, comprising the steps of calculating a coverage rate of a recording part of the image to be recorded by said recording unit; comparing said elapsed time with a first predetermined time; comparing said coverage rate of the recording part with a predetermined value; and causing said recovery unit to execute the recovery operation and then said recording unit to execute the image recording in a case where said elapsed time exceeds said first predetermined time and said coverage rate of the recording part exceeds said predetermined value, and causing said recording unit to execute the image recording without causing said recovery unit to execute the recovery operation in a case where said coverage rate of the recording part is not more than said predetermined value, when the receiving unit receives the command.

According to the first aspect, the second aspect and the third aspect, when the command to record the image is received, in the case where the elapsed time measured by the clocking means (clocking unit) exceeds the predetermined time and the coverage rate of the recording part calculated by the coverage rate calculating means (controller) exceeds the predetermined value, the image recording is performed by the recording means (recording unit) after the recovery operation has been executed. In addition, in the case where the coverage rate of the recording part is not more than the predetermined value, only the image recording is performed without executing the recovery operation.

The inventors have focused on the fact that the possibility that an ejection defect of a nozzle is low in a case where an image has a small coverage rate at a recording part because the operation amount of the nozzle for recording the image is small. That is, not only the elapsed time from the previous recovery operation, but also the coverage rate of the recording part in the image to be recorded next is taken into consideration. Thus, the recording operation is started without executing the recovery operation, depending on the coverage rate of the recording part, so that a waiting time for the recovery operation can be eliminated. In addition, the ink ejected at the time of the recovery operation can be prevented from being wasted.

The above and further objects and features will more fully be apparent from the following detailed description with accompanying drawings.

### BRIEF DESCRIPTION OF THE SEVERAL VIEWS OF THE DRAWINGS

FIG. 1 is a perspective view showing a multi function device;

FIG. 2 is a side sectional view showing the multi function device;

FIG. 3 is a schematic plan view to explain a constitution of a recording unit;

FIG. 4 is a perspective back view showing the recording unit;

FIG. 5 is a block diagram showing a control system;

FIG. 6 is a flowchart showing a first embodiment of a recovery operation;

FIG. 7 is a flowchart showing a second embodiment of the recovery operation;

FIG. 8 is a flowchart showing a third embodiment of the recovery operation;

FIG. 9 is a flowchart showing a fourth embodiment of the recovery operation;

FIG. 10 is a flowchart showing a fifth embodiment of the recovery operation;

FIGS. 11A and 11B are flowcharts showing a sixth embodiment of the recovery operation;

FIG. 12 is a bottom view showing a recording head;

FIG. 13A is a schematic view showing a region where the recording head passes by one scanning; and

FIG. 13B is an explanatory diagram to explain a coverage rate.

### DETAILED DESCRIPTION

A preferred embodiment will be described hereinafter. In this embodiment, as one embodiment of an image recording apparatus, a multi function device 1 (MFD) provided with a printer function, a copy function, a scanner function and facsimile function is applied.

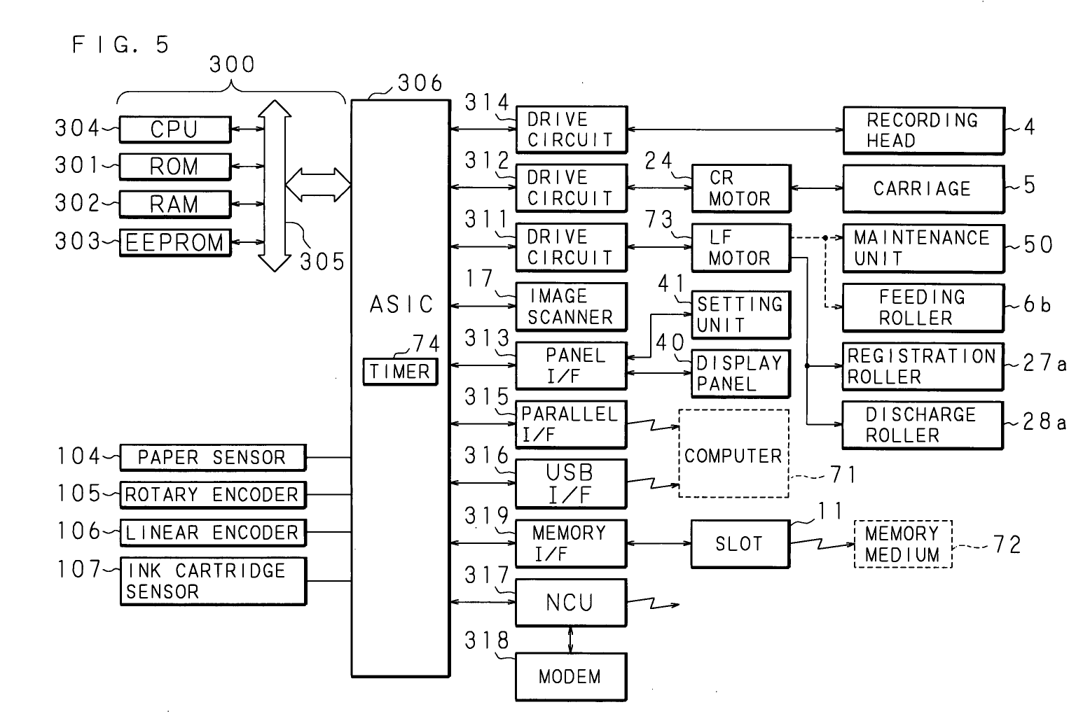

The multi function device 1 can be connected to a computer 71 such as a personal computer and a telephone communication network, and a memory medium 72 is detachably connected thereto (refer to FIG. 5). The multi function device 1 can record an image (photograph and document) on paper as a recording medium, based on image data (including photograph data and document data) obtained from an external device such as the computer 71 or another facsimile machine or the memory medium 72, or image data read from a document using the scanner function.

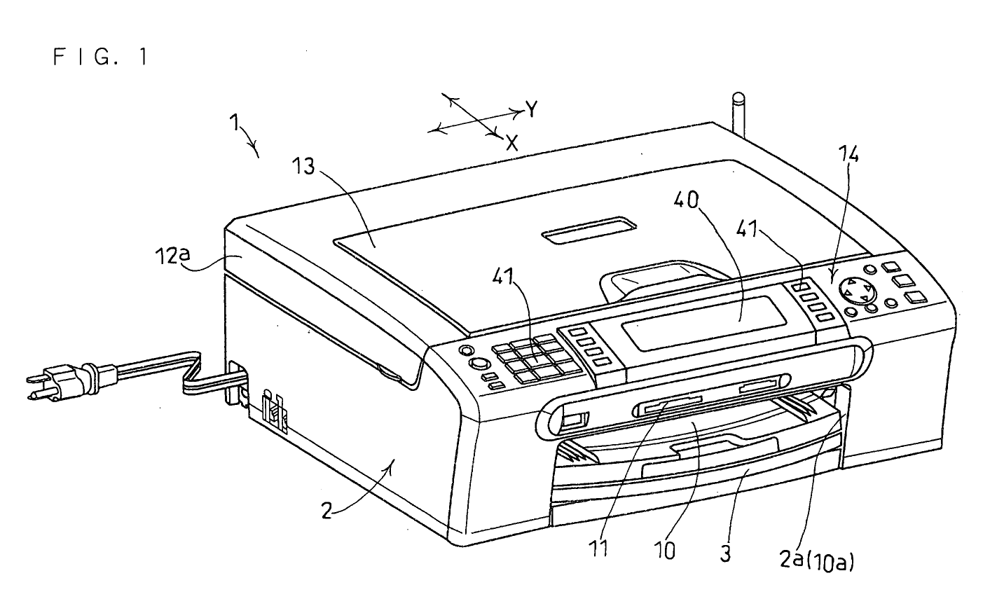

According to this embodiment, as shown in FIG. 1, a recording unit 7 (corresponding to recording means in claim) is provided at a lower part of a body case 2 serving as a device body. Thus, a paper cassette 3 is provided such that it can be mounted and dismounted (in a horizontal direction substantially) on and from a housing space at a bottom of the body case 2 through a loading port 2a that is open on a front side of the body case 2. The side having the loading slot 2a of the body case 2 is called the front side and other sides are called back (rear) and right and left sides based on the front side.

A slot 11 is provided on the front side of the body case 2 and several kinds of memory media 72 (refer to FIG. 5) on which image data, control data to control image recording and the like is recorded can be inserted into the slot 11. As the memory medium that can be inserted, a card-shaped memory including a semiconductor memory and the like can be available commercially in various sizes. The slot 11 having three different sizes shown in FIG. 1 can correspond to those various sizes. It can be detected whether the memory medium 72 is inserted in the slot 11 or not by a control unit 300 containing a CPU 304 and the like shown in FIG. 5 as will be described below.

An image reading device 12 to read a document by the copy function and facsimile function is arranged in an image reading case 12a at an upper part of the body case 2.

An operation unit 14 for various kinds of operations and displays is provided ahead of the image reading device 12, at an upper side of the body case 2. The recording unit 7 and a paper discharge tray 10 and the like are arranged in a planar projected area of the image reading device 12 and the operation unit 14.

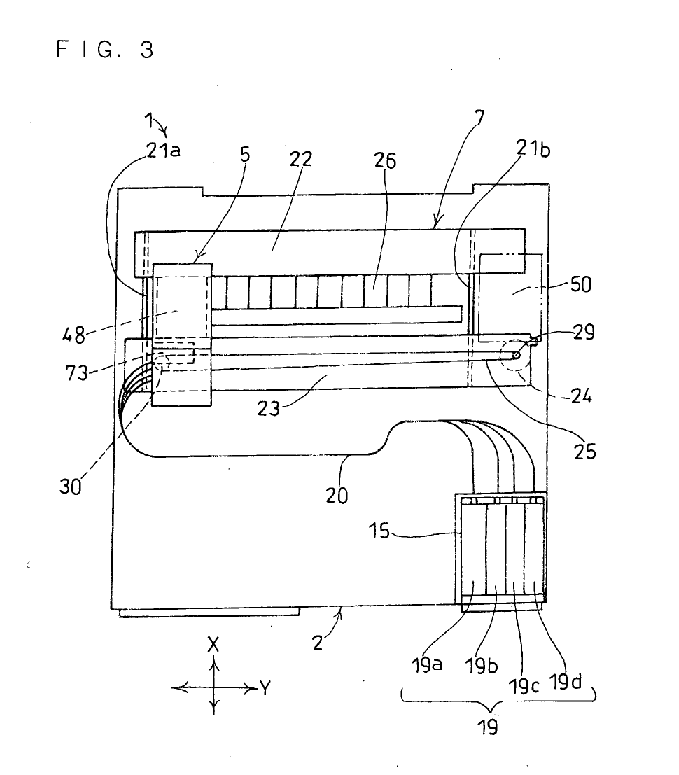

A housing 15 for an ink cartridge 19 (here, for colors such as yellow 19a, magenta 19b, cyan 19c, and black 19d) is incorporated in the machine on one side of the paper discharge tray 10 (right side in FIGS. 1 and 3) and on the front side of the body case 2. Ink of each of the ink cartridges 19a to 19d is supplied to a recording head 4 through a flexible ink supply tube 20.

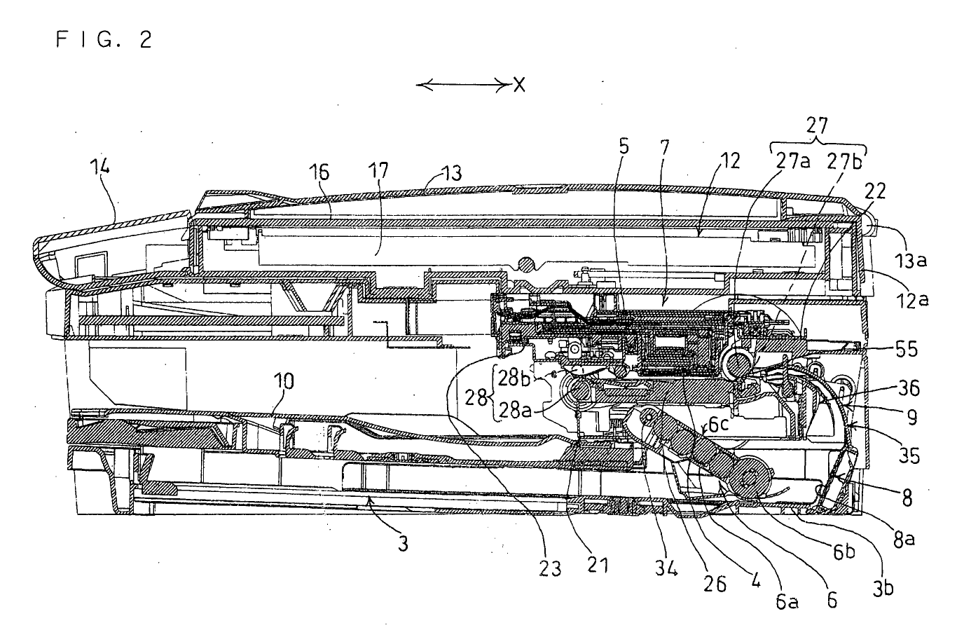

A glass plate 16 on which the document can be set is provided on an upper surface of the image reading device 12, and on lower side of the image reading device 12, an image scanner 17 for reading the document (corresponding to document reading means in claim) is provided in a direction perpendicular to the paper surface of FIG. 2 (main scanning direction of a carriage 5, Y-axis direction) so as to be able to reciprocate. A rear end (right side in FIG. 2) of a document cover body 13 covering the glass plate 16 is mounted on the image reading case 12a through a hinge 13a so as to be opened and closed.

The image of the document set on the glass plate 16 with its image surface facing downward is read while the image scanner 17 moves in the Y-axis direction and is created into image data by the control unit 300. The created image data is stored in a RAM 302 (refer to FIG. 5) as will be described below.

As shown in FIG. 2, the recording unit 7 includes various kinds of functional parts in a main frame 21 having an upper surface opening. The main frame 21 includes a pair of right and left side plates 21a and 21b and horizontally-long plate-shaped first guide member 22 and second guide member 23 supported by the side plates 21a and 21b and extending in the Y-axis direction (main scanning direction). Thus, the carriage 5 is slidably supported along both guide members 22 and 23, and a platen 26 to support the paper is positioned so as to be opposed to a lower surface of the recording head 4 mounted on the carriage 5.

The carriage 5 is connected to a timing belt 25 wound around pulleys 29 and 30 on an upper surface of the second guide member 23 and reciprocates when the pulley 29 is driven by a CR (carriage) motor 24.

A pair of registration rollers 27 for performing a conveying operation and a registering operation is positioned on an upstream side of the platen 26 in a conveyance direction. The pair of registration rollers 27 includes a driving registration roller 27a and a driven roller 27b, and conveys the paper to a gap between the nozzle surface of the lower surface of the recording head 4 and the platen 26. A pair of discharge rollers 28 is positioned on the downstream side of the platen 26 and the pair of discharging roller 28 includes a spur 28b to be in contact with an upper surface of the paper and a driving discharge roller 28a to be in contact with a lower surface of the paper and conveys the recorded paper to the paper discharge tray 10.

A tilted plate 8 having an elastic separation pad 8a for separating paper is arranged on the rear side of the paper cassette 3 (rear end side, right side in FIG. 2). Feeding means 6 having a feeding arm 6a, a feeding roller 6b and a gear transmission mechanism 6c is provided in the body case 2, and when the feeding roller 6b provided at a lower end of the feeding arm 6a is rotated by a driving shaft 34 through the gear transmission mechanism 6c, the paper stored in the paper cassette 3 is conveyed one by one.

The conveyed paper is sent to the pair of registration rollers 27 through an upward laterally-facing, viewed from the side, U-turn path (feeding path) 9 provided between a laterally-facing U-shaped outer path body 35 and an inner path body 36. The paper recorded by the recording unit 7 is discharged onto the paper discharge tray 10 with its recorded surface facing upward. The paper discharge tray 10 is provided on an upper side of the paper cassette 3 and an outlet port 10a connected to the paper discharge tray 10 (upper part of the loading port 2a, refer to FIG. 1) has an opening on the front side of the body case 2.

A detection lever 55 is provided such that it can cross the feeding path 9 and can be turned, on a downstream side of the feeding path (U-turn path) 9 so as to be able to detect a leading edge and rear edge of the paper passing through the feeding path 9 (refer to FIG. 2).

A maintenance unit 50 is provided on one end side of the recording unit 7 (in this embodiment, a part closer to a side plate 21b on the right side in FIG. 3) and the ink receiver 48 is provided on the other end side (part closer to the side plate 21a on the left side in FIG. 3), outside the width of the conveyed paper.

The ink receiver 48 is provided so as to correspond to a flashing position of the carriage 5. The recording head 4 flashes the ink periodically during a recording operation at the flashing position to prevent a nozzle from being clogged with ink and the ink is received by the ink receiver 48.

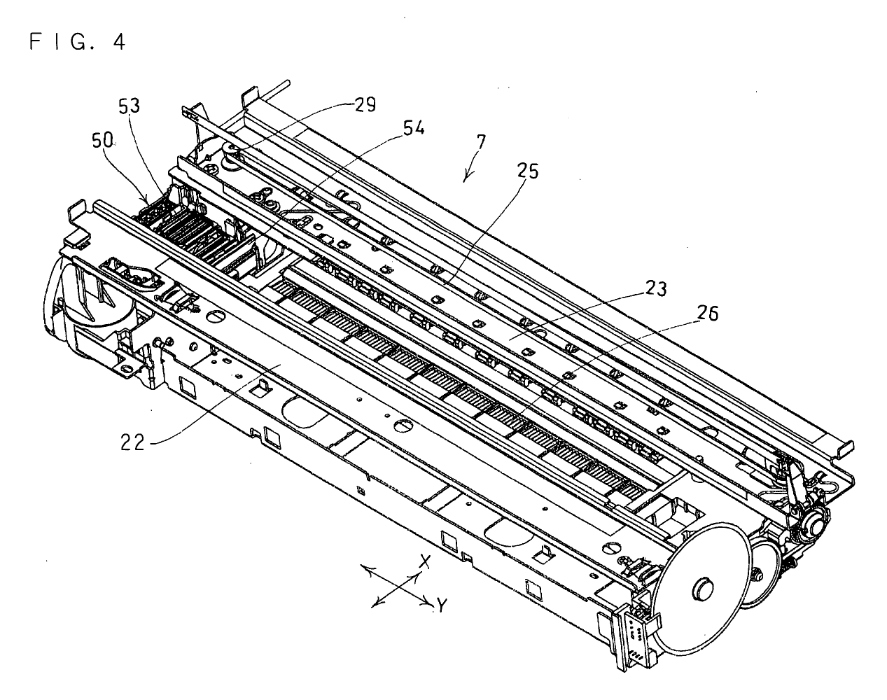

The maintenance unit 50 is provided so as to correspond to a standby position (home position) of the carriage 5, and performs a suction-recovery operation (purging) to the recording head 4. The maintenance unit 50 includes a cap body 53 connected to a pump positioned in the body case 2 and a wiper 54 for wiping the nozzle surface (refer to FIG. 4).

The recovery operation is executed by performing a single operation or combining a plurality of operations. First, the nozzle surface of the recording head 4 is covered with the cap body 53, and dry (thick) ink and bubble in the ink are sucked from the nozzle of the recording head 4. Then, the cap body 53 is separated from the nozzle surface and the nozzle surface of the recording head 4 is cleaned by the wiper 54 when the carriage 5 is to be moved from the maintenance unit 50 to the image recording region. In addition, an operation to move the carriage 5 to the flashing position and drive the recording head 4 to flash the ink toward the ink receiver 48 regardless of the recording operation is one of the recovery operations.

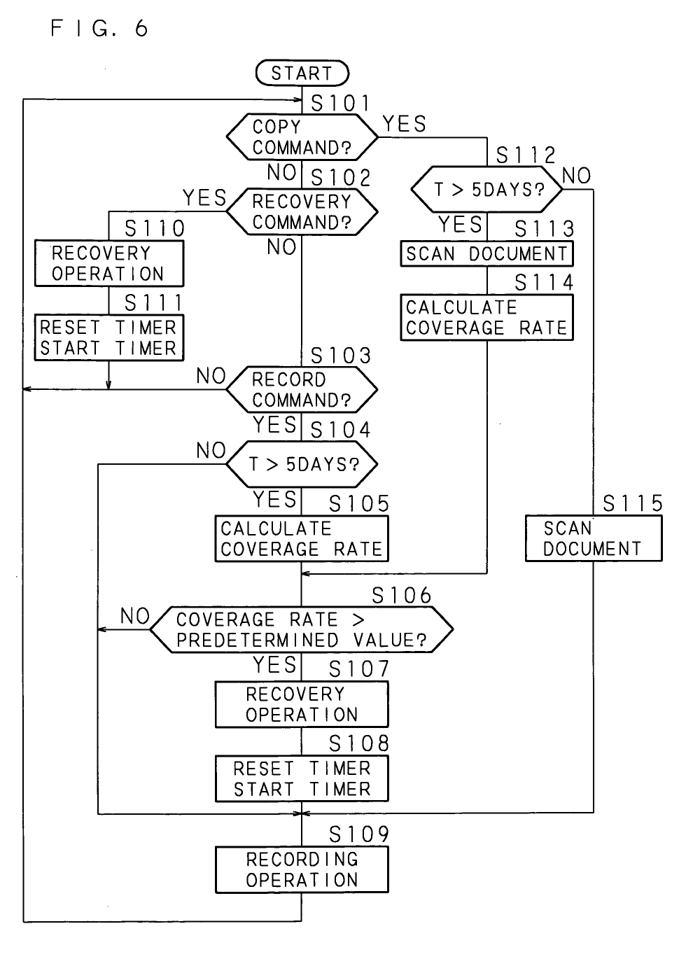

As will be described below, the recovery operation is carried out by a command of the recovery operation from a user or after a certain time has elapsed from the previous recovery operation. The “recovery operation” shown in the flowchart in FIGS. 6 to 8 includes the series of recovery operations in which the recording head is covered with the cap body 53 and the ink and the bubble in the ink are sucked by the pump and finally the nozzle surface is cleaned by the wiper 54. In addition, depending on the certain elapsed time, the degree of the recovery operation such as the repeating number of this series of recovery operations, that is, the number of sucking of the pump may be changed. The degree of the recovery operation can be changed also by controlling the length of the sucking time by the pump.

The rotation of the pump of the maintenance unit 50 and the contact and separation of the cap body 53 and the wiper 54 to the nozzle surface are driven by a LF (line feed) motor 73 (refer to FIGS. 3 and 5). The feeding roller 6b of the feeding means 6, the registration roller 27a and the discharge roller 28a other than the maintenance unit 50 can be driven by switching a rotation direction of the LF motor 73.

The operation unit 14 will be described. The operation unit 14 is provided so as to have almost the same width as a lateral width of the multi function device 1 on the upper front side of the body case 2. As a whole, the operation unit 14 is arranged so as to be descent toward the front side so that the user can easily operate. A display panel 40 of a liquid crystal screen is positioned in the center of the operation unit 14. This display panel 40 is provided such that its rear end side can be turned vertically through a hinge provided on its front end side and the angle of the display panel 40 can be adjusted so that the use can easily see it.

A setting unit 41 to select or set various kinds of functions (operations) provided in the multi function device 1 include a plurality of buttons and numeric keypad arranged on both sides of the display panel 40 in the operation unit 14. The buttons include function keys shown by “fax”, “scan”, “copy”, and “digital camera print”. When the function key is pressed, any one of the facsimile function, scan function, copy function and print function of the image data in the memory medium can be selected and carried out. In addition to the above, a button to command the recovery operation of the recording head is also provided. In addition, buttons provided in the setting unit 41 also includes an image scroll button and a selection button by which the item displayed on the screen of the display panel 40 can be selected or set to command the operation.

Next, the control unit of the multi function device 1 (image recording apparatus) will be described with reference to FIG. 5. The control unit controls the whole operations of the multi function device 1.

The control unit 300 (corresponding to controlling means in claim) mainly includes a microcomputer including the CPU 304, a ROM 301, the RAM 302 and an EEPROM 303, and an ASIC (Application Specific Integrated Circuit) 306 connected to the microcomputer through a bus 305. A timer 74 (corresponding to clocking means in claim) to measure a time T elapsed from the previous recovery operation by the maintenance unit 50 is incorporated in the ASIC 306 or the microcomputer.

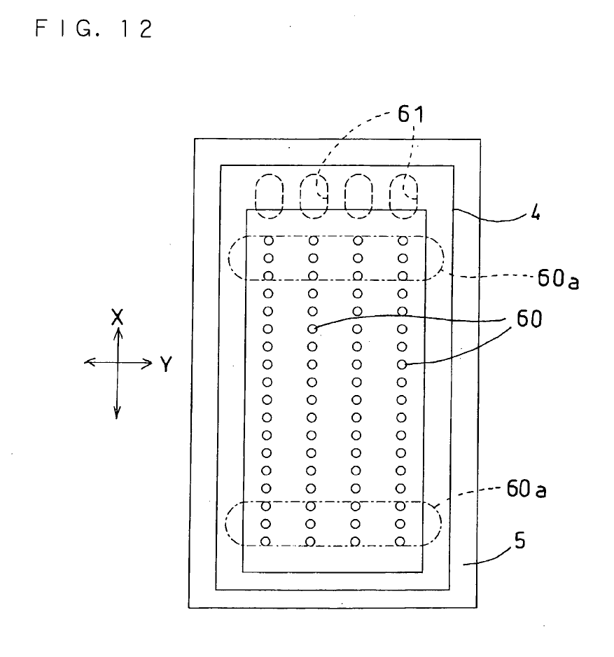

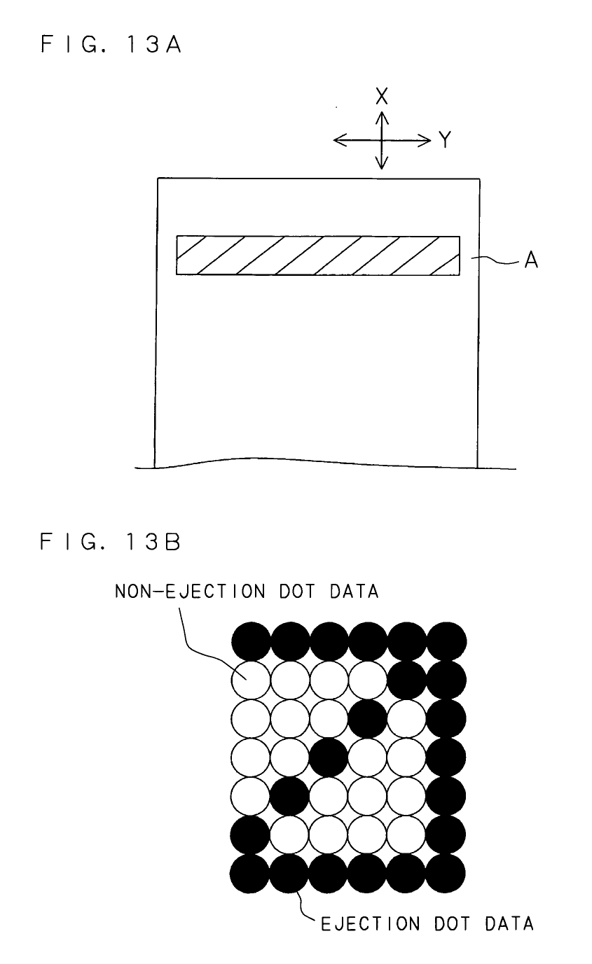

In addition, coverage rate calculating means to calculate a coverage rate in a recording part of the image to be recorded by the recording unit 7 is provided in the ASIC 306 or the microcomputer. The various kinds of images to be recorded by the recording unit 7 is stored as image data (a part of which is shown as an image in FIG. 13B) in an image data region in the RAM 302 and data is sequentially read from this region in the main scanning direction of the recording head 4 and supplied to the recording head 4. Thus, the data is recorded on the paper.

The above coverage rate is designated by η defined as follows.

η=Sb/Sa×100 (%) where Sa: whole area of print paper (size defined by the JIS (Japanese Industrial Standards)) and Sb: total area of print part.

There are two methods depending on a difference in calculation method of the total area of the print part.

### (1) Image Area Ratio (Print Coverage)

In this method, the total area Sb of the print part is set to an area of the print part on the paper outputted actually. According to this method, there is a difference in value depending on measuring equipment for measuring the total area of the print part and a measuring threshold level.

In addition, in a case where a print thickness is changed during the printing, the total area of the print part is re-measured with respect to each change to precisely express the value, which is troublesome.

### (2) Image Dot Ratio

In this method, the total area Sb of the print part is set to an area calculated by the number of dots of a print data ON signal to be outputted. In this case, the above Sa and Sb are as follows. (refer to FIG. 13B)

Sa: whole area of paper to be outputted (or the number of dots when whole area of paper is printed in black)

Sb: area of print part calculated by the number of dots of the print data ON signal to be outputted on that page (or the number of dots of the print data ON signal on that page)

In an electrophotographic type of printer, the image dot ratio is smaller than the image area ratio in general. For example, area ratio 5%≅dot ratio 4%.

Although the method (1) was used conventionally in many cases, the method (2) has been increasingly used recently. The method (1) is based on an idea to express the characteristics of a test chart used as a standard document in a copying machine. The method (2) is based on data to be printed, which is suitable for a printer using an electric signal (there is no document).

Needless to say, both methods (1) and (2) can be employed in this embodiment.

In addition, as described above, the Sa is defined as the whole area of the paper, and the image data stored in the image data region may be for one page of the paper or may be a predetermined area A that can be recorded by scanning the recording head 4 several times (refer to hatching region in FIG. 13A).

As will be described below, the coverage rate is used as a target for a nozzle ejection defect when the recording operation is continued over the predetermined elapsed time from the previous recovery operation. In this respect, the coverage rate may be calculated based on the image data in a region to be recorded by a nozzle positioned at an end of a line among the nozzles arranged in lines in the recording head 4.

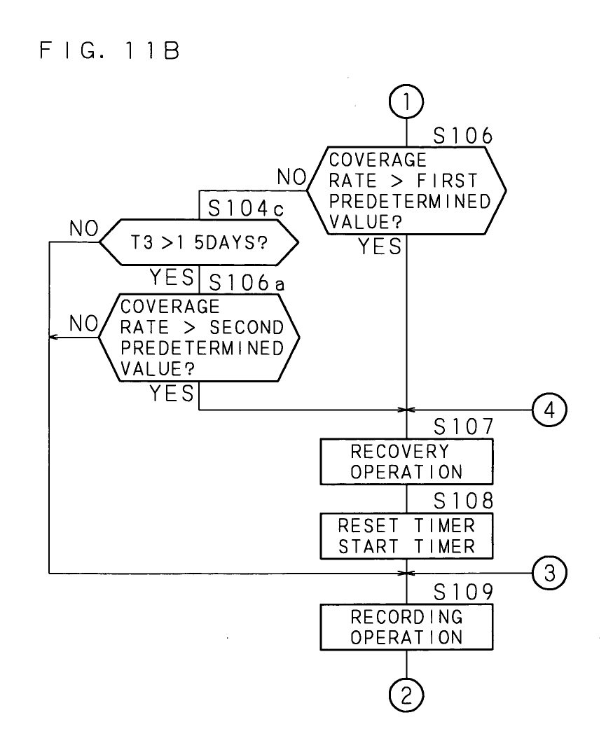

FIG. 12 shows a bottom view of the recording head 4. The many nozzles 60 are provided in a line along a sub scanning direction (X-axis direction) and are arranged in four lines for colors (yellow, magenta, cyan, and black in this example) in the main scanning direction at intervals. Since the ink is supplied from a supply port 61 to each nozzle along the line similar to the well-known one, nozzles 60a positioned at the end of the line are likely to be clogged due to the bubble in the ink as compared with other nozzles. Thus, when the coverage rate is calculated based on the image data to be recorded by the nozzle 60a positioned at the end of the line, the ink ejection defect can be avoided with higher precision as compared with the case where the coverage rate is calculated from the entire image data.

According to this embodiment, a value obtained by adding the coverage rates of the colors in the nozzle line (using the above method (2) in this case) is used as the coverage rate. That is, when the coverage rate of the yellow in the nozzle line is 5%, the coverage rate of the magenta in the nozzle line is 10%, the coverage rate of the cyan in the nozzle line is 15%, and the coverage rate of the black in the nozzle line is 20%, the coverage rate becomes 50%. As will be described below, in the case where the coverage rate 50% is beyond a predetermined value, the recovery operation is performed for all the nozzles.

A program to control each operation of the multi function device 1 is stored in the ROM 301, and the RAM 302 is used as a memory region or a operation region to store various kinds of data temporally when the CPU 300 carries out the above program. The image data that was read by the image scanner 17 and created, image data obtained from the external device such as the computer 71 and another facsimile device or from the memory medium 72 are also temporarily stored in the image data region of the RAM 302.

The ASIC 306 is connected to NCU (Network Control Unit) 317, and a communication signal inputted from the public switched telephone network (PSTN) through the NCU 317 is demodulated by a modem 318 and then inputted to the ASIC 306. In addition, when the ASIC 306 transmits image data to the outside through the facsimile transmission and the like, the image data is modulated to a communication signal by the modem 318 and the communication signal is outputted to the PSTN through the NCU 317.

In addition, the ASIC 306 generates a phase exciting signal and the like to turn on each motor, for example, according to the command from the microcomputer and applies the signal to a drive circuit 311 of the LF motor 73 and to a drive circuit 312 of the CR motor 24 to control the LF motor 73 and the CR motor 24.

Furthermore, the ASIC 306 is connected to the image scanner 17 for reading the document, a panel interface 313 for the display panel 40 and setting unit 41 for the various kinds of operations, a parallel interface 315 and a USB interface 316 for transmitting and receiving data to and from the external device such as the personal computer 71 through a parallel cable and an USB cable, and a memory interface 319 for the slot 11 serving an external input terminal to which the memory medium 72 is inserted, and the like. In addition, in this embodiment, the parallel interface 315, the USB interface 316, the memory interface 319 and the NCU 317 correspond to obtaining means in claim. In addition, the panel interface 313, the parallel interface 315, the USB interface 316, and the NCU 317 correspond to receiving means in claim.

Furthermore, the ASIC 306 is connected to a paper sensor 104 provided so as to be related to the detection lever 55 (refer to FIG. 2) provided on the transmission downstream side of the feeding path 9, a rotary encoder 105 for detecting the rotation speed of the registration roller 27, a linear encoder 106 for detecting the moved amount of the carriage 5, and an ink cartridge sensor 107 for detecting that the ink cartridge 19 is exchanged, and the like (refer to FIG. 5).

The drive circuit 314 is provided to eject the ink selectively to the paper from the recording head 4 at a predetermined timing and when the drive circuit 314 receives a signal generated and outputted by the ASIC 306 based on the program of the microcomputer, the drive circuit 314 drives the recording head 4.

Next, a first embodiment of control related to the recovery operation of the multi function device 1 will be described with reference of a flowchart shown in FIG. 6.

The multi function device 1 generates a copy command to copy the document, that is, generates a command to read the document and record it on the recording medium (Yes in S101). More specifically, when the document is set on the glass plate 16 with its image surface facing downward and the copy button of the setting unit 41 is pressed, the elapsed time (counted value) T from the previous recovery operation, measured by the timer 74 is confirmed (S112).

In either case the counted value T exceeds 5 days (Yes in S112) or the counted value T is not more than 5 days (No in S112), the document is scanned (S113 and S115) and the document is read and image data is created and stored in the RAM 302.

Then, when the counted value T is not more than 5 days (No in S112), the recording is performed on the paper immediately according to the created image data (S109). Meanwhile, when the counted value T exceeds 5 days (Yes in S112), the coverage rate is calculated based on the image data stored in the RAM 302 (S114).

When the calculated coverage rate is more than a predetermined value (80%, for example) (Yes in S106), the recovery operation is carried out (S107). When the coverage rate is more than the predetermined value, that is, when the image data to be recorded needs a lot of ink as a whole, the ejection defect could be caused during the recording operation unless the recovery operation is carried out according to the experience of the inventor. Thus, the recovery operation is carried out before the next recording operation. When the recovery operation is completed, the counted value T of the timer 74 is reset and the timer 74 is started again (S108) and the image data stored in the RAM 302 is recorded on the paper (S109).

When the coverage rate is not more than the predetermined value (No in S106), the recording is performed without carrying out the recovery operation (S109). In the case where the image data to be recorded next does not need a lot of ink as a whole, even when the recovery operation is not carried out, it is not likely that the ejection defect occurs according to the experience of the inventor. Therefore, the recording is immediately performed without performing the recovery operation.

Even when there is no copy command (No in S101), in the case where the user gives a recovery command (Yes in S102), the recovery operation is immediately carried out (S110), the counted value T of the timer 74 is reset and the timer 74 is started again (S111), and the next command is waited.

In addition, when there is no copy command and no recovery command (No in S101 and No in S102) but there is a record command (Yes in S103), by the user, the counted value T of the timer 74 is detected and it is determined whether the counted value T exceeds 5 days or not (S104). The record command in this embodiment includes a record command of the image data received from the personal computer 71 or image data from another facsimile machine and a record command of the image data of the memory medium 72 inserted in the slot 11 received through the setting unit 41.

When the record command is given (Yes in S103), the obtained image data is temporarily stored in the RAM 302. When the counted value T of the timer 74 is not more than 5 days (No in S104), the image data is recorded on the paper without performing the recovery operation (S109).

When the counted value T of the timer 74 exceeds 5 days (Yes in S104), the coverage rate is calculated for the image data stored in the RAM 302 (S105). When the coverage rate is more than the predetermined value (Yes in S106), the recovery operation is carried out (S107) and the counted value T of the timer 74 is reset and the timer 74 is started again (S108) and the image data is recorded on the paper (S109).

Even when the counted value T of the timer 74 exceeds 5 days (Yes in S104), in the case where the calculated coverage rate is not more than the predetermined value (No in S106), the image data is recorded on the paper without performing the recovery operation (S109).

As described above, according to the first embodiment, it is determined whether the recovery operation is necessary or not by considering whether the elapsed time from the pervious recovery operation exceeds the predetermined time (5 days) or not and also considering the coverage rate of the read or received image data. More specifically, since the image data having the coverage rate smaller than the predetermined value needs a small amount of ink ejection (nozzle running) when it is recorded, even when the elapsed time exceeds the predetermined time, it is not likely that the ejection defect occurs. In the case where the recovery operation is carried out only by considering the elapsed time like the conventional case, the recovery operation is carried out beyond necessity and as a result, it needs time to wait for the recovery operation before the recording operation and the ink is consumed vainly. However, by considering the coverage rate also, this problem can be solved.

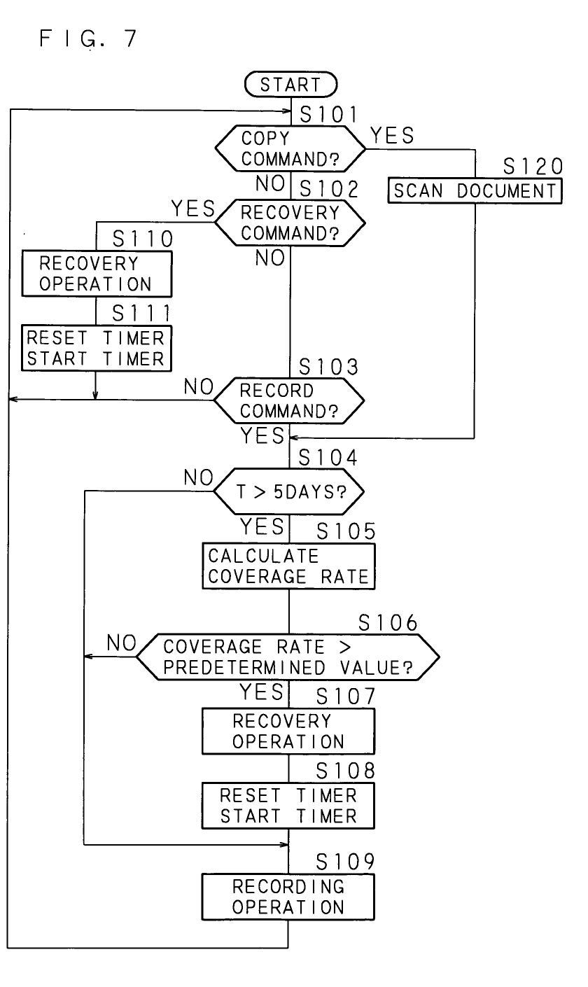

In addition, the flowchart shown in FIG. 6 can be modified unless the above point is deviated. For example, as shown in a second embodiment shown in FIG. 7, when the copy command is given (Yes in S101), it may be modified such that the document is read first (S120) and then the counted value is confirmed (S104). In addition, since S101 to S111 in FIG. 7 are the same as the S101 to S111 in FIG. 6 in the first embodiment, their description will be omitted.

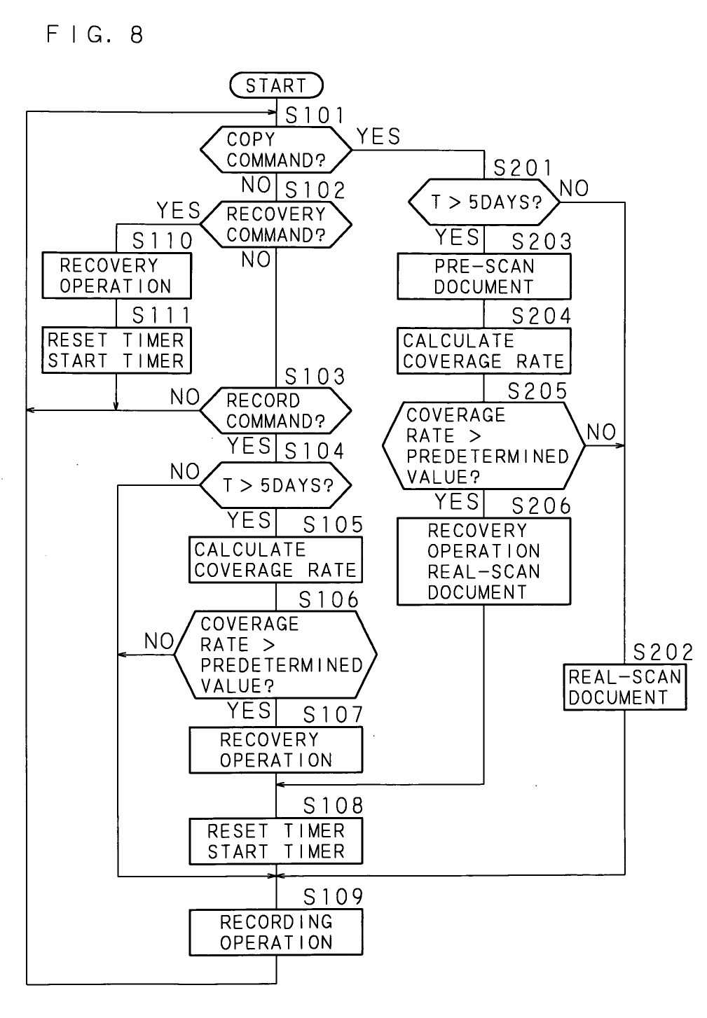

Next, a third embodiment will be described with reference to a flowchart shown in FIG. 8. In addition, since S101 to S111 in FIG. 8 are the same as the S101 to S111 in FIG. 6 in the first embodiment, their description will be omitted.

A multi function device 1 according to the third embodiment reads a document set on a glass plate 16 in a “real document scan” (the same as the “document scan” in the first embodiment) mode and in a “document pre-scan” mode. According to the “real document scan” mode, the document is read at a resolution specified to record the document and the image scanner 17 performs scanning at a reading speed corresponding to the resolution. According to the “document pre-scan” mode, the document is read at a resolution lower than that in the real document scan mode and the image scanner 17 performs scanning at a speed higher than that of the real document scan mode.

While the data created by reading the document by the real document scan is called the real scan image data, the data created by reading the document by the document pre-scan is called the pre-scan image data in the following description for simplifying the description. Although the document pre-scan mode is only for the display of the personal computer 71 or the display on the display panel 40 originally, it is used to calculate the coverage rate of the image data in this embodiment as will be described below.

When a copy command to copy the document is given in the multi function device 1 (Yes in S101), a time (counted value) measured by the timer 74 is confirmed like the above embodiment (S201).

When the counted value T exceeds 5 days (Yes at S201), the document pre-scan to read the document at speed higher than usual is performed first (S203), and the created pre-scan image data is stored in a RAM 302. Then, the coverage rate of the pre-scan image data is calculated (S204) and when the coverage rate is more than the predetermined value (Yes at S205), the recovery operation and the real document scan are performed at the same time (S206). The real scan image data created by the real document scan is stored in the RAM 302 and the previously stored pre-scan image data is erased from the RAM 302 (the pre-scan image data is overwritten with the real scan image data).

In addition, at this time, the microcomputer controls the image scanner 17 and the maintenance unit 50 based on a program such that they are driven alternately in a short time and operated in parallel substantially. Alternatively, hardware circuits to carry out a series of operations of each of the image scanner 17 and the maintenance unit 50 may be provided in an ASIC 306 respectively. In this case, when the microcomputer gives a command to start the operation to the hardware circuits, the hardware circuits drive the image scanner 17 and the maintenance unit 50, respectively in parallel.

When the recovery operation is completed, the counted value T of the timer 74 is reset, and the timer 74 is started again (S108) and the real scan image data created by the real document scan is recorded on paper (S109).

When the counted value T is not more than 5 days (No at S201), the real document scan is carried out (S202) without performing the document pre-scan and calculating the coverage rate and the real scan image data created by reading the document is stored in a RAM 302. Then, the real scan image data stored in the RAM 302 is recorded on the paper (S109) without performing the recovery operation.

When the coverage rate of the pre-scan image data is not more than the predetermined value (No at S205), the real document scan is carried out (S202) and the real scan image data is formed by reading the document and the pre-scan image data is replaced with the real scan image data in the RAM 302 and stored. Then, the real scan image data stored in the RAM 302 is recorded on the paper (S109) without performing the recovery operation.

Thus, according to the third embodiment, the two kinds of reading speeds of the document are set and the pre-scan image data created by reading the document at high speed is used for the calculation of the coverage rate and the real scan image data created by reading the document at low speed is used to be recorded. Since the calculated coverage rate is only have to be a roughly outline as the coverage rate of the recording part, it may be calculated with the low-resolution data without using the high-resolution real scan data.

Thus, as a result of the calculation of the coverage rate, when the recovery operation is needed, since the real document scan is performed by the image scanner 17 while the recovery operation is carried out by the maintenance unit 50 at the same time, a time can be shortened even when the document is scanned two times (pre-scan and real scan).

In each of the above embodiments, calculation may be made using image data obtained by scanning a part of the document instead of scanning the whole part of the document.

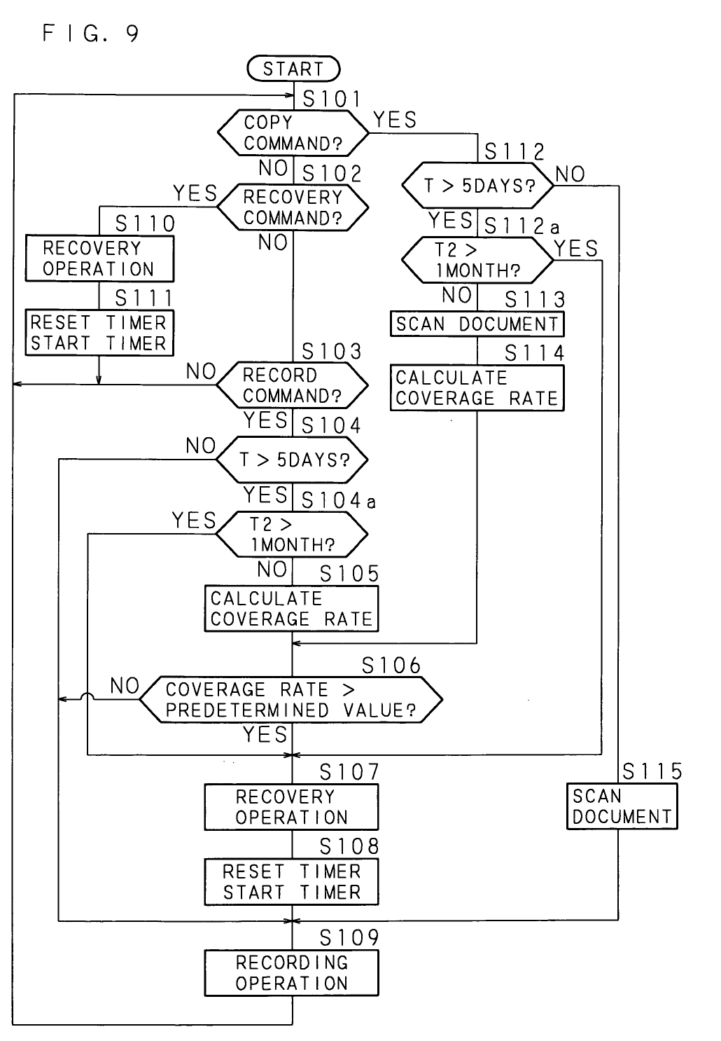

FIG. 9 shows a fourth embodiment and the same reference symbols are given to the same parts in the first embodiment and their description will be omitted. According to this embodiment, after the operations to determine whether the time T measured by the timer 74 exceeds 5 days or not (S104 and S112), operations to confirm whether a time T2 measured by the timer 74 exceeds 1 month or not are performed (S104a and S112a).

More specifically, in a case where a long time has passed from the previous recovery operation, it is highly likely that ink becomes thick or dried and clogged in a nozzle. Thus, in the case where the time exceeds 1 month (Yes in S104a and Yes in S112a), the recovery operation is performed (S107). When the time is not more than 1 month (No in S104a and No in S112a), the coverage rate is calculated and it is determined whether the recovery operation is to be performed or not based on the coverage rate, similar to the first embodiment.

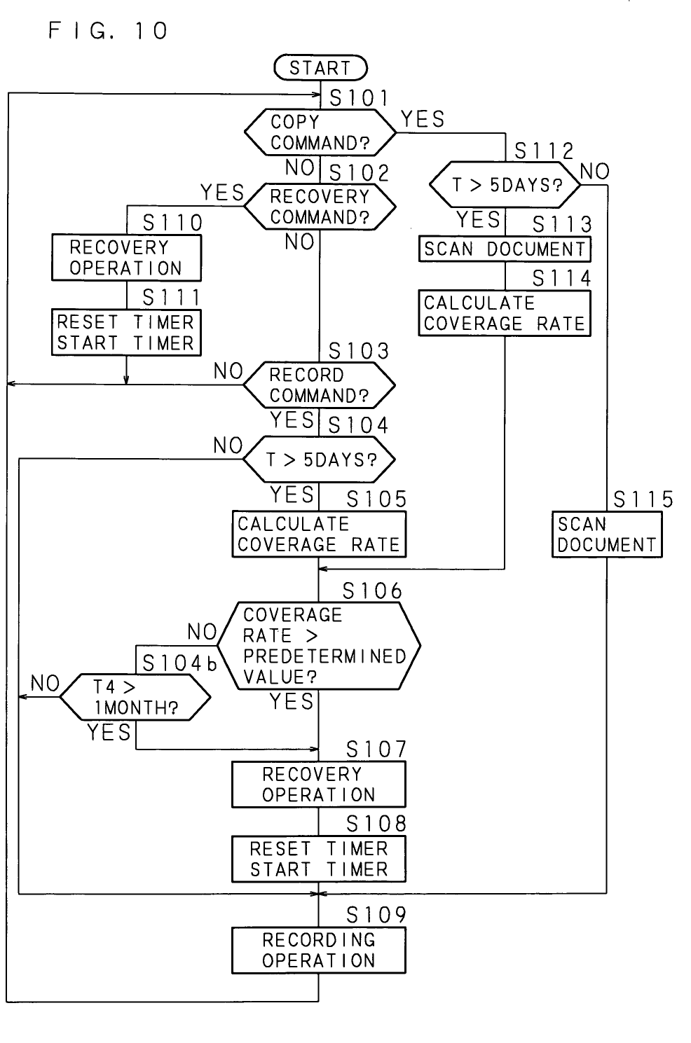

FIG. 10 shows a fifth embodiment and the same reference symbols are given to the same parts in the first embodiment and their description will be omitted. According to this embodiment, after the operation to determine whether the coverage rate is not more than the predetermined value (106), an operation to confirm whether a time T4 measured by the timer 74 exceeds 1 month or not (S104b) is performed.

More specifically, in the case where the coverage rate is not more than the predetermined value (No in S106) and the time from the previous recovery operation is not more than 1 month (No in S104b), since it is not highly likely that an ejection defect occurs even when the recovery operation is not carried out, the recording can be performed. Meanwhile, in the case where the time exceeds 1 month (Yes in S104b), since it is highly likely that ink becomes thick or dried and clogged in a nozzle, the recovery operation is performed (S107) and then recording operation is performed.

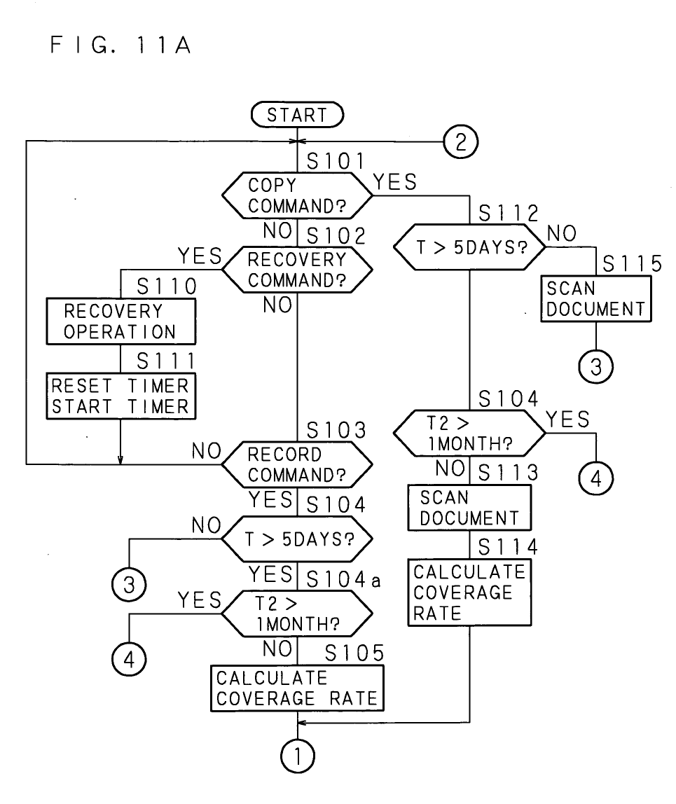

FIGS. 11A and 11B show a sixth embodiment and the same reference symbols are given to the same parts in the fourth embodiment and their description will be omitted. According to this embodiment, elapsed times to determine whether the recovery operation is needed or not are set in two stages (S104 and S104c) and coverage rates are set in also two stages so as to correspond to the elapsed times (S106 and S106a). Similar to the fourth embodiment, in the case where the time elapsed from the previous recovery operation exceeds 5 days but not more than 1 month (Yes in S104 and No in S104a), when the coverage rate is more than a first predetermined value (80%, for example) (Yes in S106), the recovery operation is performed (S107) and then the recording operation is performed.

When the coverage rate is not more than the first predetermined value (No in S106) and the elapsed time from the previous recovery operation T3 is not more than 15 days (No in S104c), since an ejection defect is not likely caused even though the recovery operation is not carried out, recording can be performed. When the elapsed time T3 exceeds 15 days (Yes in S104c), and the coverage rate is not more than a second predetermined value (50%, for example) (No in S106a), the recording operation is performed similarly. When the elapsed time T3 exceeds 15 days (Yes in S104c) and the coverage rate is more than the second predetermined value (Yes in S106a), the recovery operation is performed (S107) and then the recording operation is performed.

In this embodiment also, when the elapsed time from the previous recovery operation exceeds 1 month, the recovery operation is performed regardless of the coverage rate.

Thus, in the case where the elapsed time from the previous recovery operation is long, when the coverage rate used for determination at that time is set to a low value, the recording operation can be performed without nozzle clogging according to the progress of the thickness or drying of the ink. In addition, since it is determined precisely whether the recovery operation is carried out or not, a waiting time due to the recovery operation can be eliminated, and ink consumption ejected at the time of the recovery operation can be reduced. In addition, the elapsed times to determine whether the recovery operation is to be performed or not may be set in more stages and the coverage rates may be set in more stages.

In addition, although the predetermined time to determine the length of the elapsed time from the previous recovery operation is 5 days, 15 days, and 1 month and the coverage rate is 80% and 50% in the above description of each embodiment, these are only one example and the time and the coverage rate can be set arbitrarily according to the constitution and performance of the multi function device 1.

In addition, although the total value of the coverage rates of the nozzle lines of the colors is compared with the predetermined value in the above embodiment, it may be such that the coverage rate of the nozzle line of each color is compared with the predetermined value and the recovery operation is selectively performed with respect to each nozzle line of each color. In this case, the predetermined value to be compared is as small as 15%, for example. In addition, both comparison with the total value and comparison with the value of each nozzle line of each color may be performed.

In addition, although the description has been made using the multi function device 1 in the above embodiments, it may be applied to a single function device such as a copy machine, a printer, a facsimile machine.

Furthermore, although the multi function device 1 (image forming device) itself calculates the coverage rate, compares the calculated coverage rate or the elapsed time with the predetermined value, and determines whether the recovery operation is to be performed or not based on the compared result to control the recovery operation in the above embodiments, it is not limited to this.

For example, when the multi function device 1 is connected to the computer 71 and used, a driver (program) may be installed in the computer 71 so that the computer controls the multi function device 1. In this case, the computer 71 (driver (program)) may perform the “calculation of the coverage rate”, “comparison between the calculated coverage rate or elapsed time and the predetermined value”, and “transmission of a command for the recovery operation to the multi function device”.

More specifically, in the case where the user sends a print command to the multi function device 1 by operating the computer 71, when the driver (program) receives the print command, the driver performs the following operations. First, the driver transmits a command to request data regarding an elapsed time from the previous recovery operation, to the multi function device 1 and obtains the data of the elapsed time. Then, it determines whether the elapsed time exceeds the predetermined value or not. When the elapsed time does not exceed the predetermined value, the computer 71 transmits both print command and image data to the multi function device 1, and causes the multi function device 1 to perform the print operation.

When the elapsed time exceeds the predetermined value, before the computer 71 transmits the print command and the image data to the multi function device 1, the driver (program) performs the following operations. That is, it calculates a “coverage rate” of the image data to be transmitted and compares the calculated coverage rate with the predetermined value. When the coverage rate is not more than the predetermined value, the computer 71 transmits the print command and the image data to the multi function device 1 and the print operation is performed.

When the coverage rate is more than the predetermined value, the computer 71 transmits a command to perform the recovery operation, to the multi function device 1. After the command has been transmitted, the computer 71 transmits the print command and the image data to the multi function device 1.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. An image recording apparatus comprising:
a recording unit ejecting ink from a nozzle to a recording medium to record an image;
a recovery unit performing a recovery operation to recover an ejecting condition of said nozzle;
a clocking unit measuring an elapsed time from a previous recovery operation by said recovery unit;
a receiving unit receiving a command to record the image on the recording medium, and
a controller capable of:
calculating a coverage rate of a recording part of the image to be recorded by said recording unit;
comparing said elapsed time with a first predetermined time;
comparing said coverage rate of the recording part with a predetermined value; and
causing said recovery unit to execute the recovery operation and then said recording unit to execute the image recording in a case where said elapsed time exceeds said first predetermined time and said coverage rate of the recording part exceeds said predetermined value, and causing said recording unit to execute the image recording without causing said recovery unit to execute the recovery operation in a case where said coverage rate of the recording part is not more than said predetermined value, when said receiving unit receives said command.

2. The image recording apparatus according to claim 1, wherein said controller is further capable of causing said recording unit to execute the image recording without causing said recovery unit to execute the recovery operation in a case where said elapsed time is not more than said first predetermined time.

3. The image recording apparatus according to claim 1, wherein said controller is further capable of causing said recovery unit to execute the recovery operation and then said recording unit to execute the image recording in a case where said elapsed time exceeds a second predetermined time longer than said first predetermined time when said receiving unit receives said command.

4. The image recording apparatus according to claim 1, wherein a plurality of stages of said first predetermined times are provided and said predetermined value of the coverage rate is provided with respect to each of said plurality of stages of the first predetermined times.

5. The image recording apparatus according to claim 4, wherein said controller is further capable of causing said recovery unit to execute the recovery operation and then said recording unit to execute the image recording in a case where said elapsed time exceeds a second predetermined time longer than each of said first predetermined times.

6. The image recording apparatus according to claim 1, further comprising a document reading unit reading a document to create image data to be formed by said recording unit,
wherein said controller is further capable of calculating a coverage rate of a recording part based on the image data of the document read by said document reading unit.

7. The image recording apparatus according to claim 6, wherein said controller is further capable of causing said document reading unit to read the document in a time shorter than an original reading time of said document reading unit, and calculating a coverage rate of the recording part based on the image data of the document read in the shorter time, before said document reading unit reads the document.

8. The image recording apparatus according to claim 1, further comprising an obtaining unit obtaining image data to be formed by said recording unit,
wherein said controller is further capable of calculating a coverage rate of a recording part based on the image data of the document obtained by said obtaining unit.

9. The image recording apparatus according to claim 1, wherein said recording unit comprises a plurality of nozzles in a line, and
said controller is further capable of calculating a coverage rate of a recording part based on said image at a part corresponding to an ejected part of a nozzle positioned at an end of said line.

10. The image recording apparatus according to claim 1, wherein said recording unit comprises a plurality of nozzles for each of a plurality of ink colors in a line.

11. The image recording apparatus according to claim 10, wherein said controller is further capable of:
calculating a coverage rate of a recording part with respect to said each ink color and adding the coverage rates of said ink colors;
comparing said total coverage rate of the recording part with a predetermined value; and
causing said recovery unit to execute the recovery operation and then said recording unit to execute the image recording in a case where said elapsed time exceeds said first predetermined time and said total coverage rate of the recording part exceeds said predetermined value, and causing said recording unit to execute the image recording without causing said recovery unit to execute the recovery operation in a case where the total coverage rate of the recording part is not more than said predetermined value.

12. The image recording apparatus according to claim 10, wherein said controller is further capable of:
calculating a coverage rate of a recording part with respect to said each ink color;
comparing said coverage rate of the recording part with a predetermined value with respect to said each ink color; and
causing said recovery unit to execute the recovery operation and then said recording unit to execute the image recording in a case where said elapsed time exceeds said first predetermined time and said coverage rate of the recording part exceeds said predetermined value, and causing said recording unit to execute the image recording without causing said recovery unit to execute the recovery operation in a case where said coverage rate of the recording part is not more than said predetermined value, with respect to said each ink color.

13. An image recording apparatus comprising:
recording means for ejecting ink from a nozzle to a recording medium to record an image;
recovering means for performing a recovery operation to recover an ejecting condition of said nozzle;
clocking means for measuring an elapsed time from a previous recovery operation by said recovery unit;
receiving means for receiving a command to record the image on the recording medium;
coverage rate calculating means for calculating a coverage rate of a recording part of the image to be recorded by said recording means;
comparing means for comparing said elapsed time with a first predetermined time;
comparing means for comparing said coverage rate of the recording part with a predetermined value; and
controlling means for causing said recovering means to execute the recovery operation and then said recording means to execute the image recording in a case where said elapsed time exceeds said first predetermined time and said coverage rate of the recording part exceeds said predetermined value, and causing said recording means to execute the image recording without causing said recovering means to execute the recovery operation in a case where said coverage rate of the recording part is not more than said predetermined value, when the receiving means receives the command.

14. The image recording apparatus according to claim 13, wherein said controlling means causes said recording means to execute the image recording without causing said recovering means to execute the recovery operation in a case where said elapsed time is not more than said first predetermined time.

15. The image recording apparatus according to claim 13, wherein said controlling means causes said recovering means to execute the recovery operation and then said recording means to execute the image recording in a case where said elapsed time exceeds a second predetermined time longer than said first predetermined time when said receiving means receives said command.

16. The image recording apparatus according to claim 13, wherein a plurality of stages of said first predetermined times are provided and said predetermined value of said coverage rate is provided with respect to each of said plurality of stages of the first predetermined times.

17. The image recording apparatus according to claim 16, wherein said controlling means causes said recovering means to execute the recovery operation and then said recording means to execute the image recording in a case where said elapsed time exceeds a second predetermined time longer than each of said first predetermined times.

18. The image recording apparatus according to claim 13, further comprising document reading means for reading a document to create image data to be formed by said recording means,
wherein said coverage rate calculating means calculates a coverage rate of a recording part based on the image data of the document read by said document reading means.

19. The image recording apparatus according to claim 18, wherein said controlling means causes said document reading means to read the document in a time shorter than an original reading time of said document reading means, and said coverage rate calculating means calculates a coverage rate of the recording part based on the image data of the document read in the shorter time, before said document reading means reads the document.

20. The image recording apparatus according to claim 13, further comprising obtaining means for obtaining image data to be formed by said recording means,
wherein said coverage rate calculating means calculates a coverage rate of a recording part based on the image data of the document obtained by said obtaining means.

21. The image recording apparatus according to claim 13, wherein said recording means comprises a plurality of nozzles in a line, and
said coverage rate calculating means calculates a coverage rate of a recording part based on said image at a part corresponding to an ejected part of a nozzle positioned at an end of said line.

22. The image recording apparatus according to claim 13, wherein said recording means comprises a plurality of nozzles for each of a plurality of ink colors in a line.

23. The image recording apparatus according to claim 22, wherein said coverage rate calculating means calculates a coverage rate of a recording part with respect to said each ink color and adds the coverage rates of said ink colors,
said comparing means compares said total coverage rate of the recording part with a predetermined value; and
said controlling means causes said recovering means to execute the recovery operation and then said recording means to execute the image recording in a case where said elapsed time exceeds said first predetermined time and said total coverage rate of the recording part exceeds said predetermined value, and causes said recording means to execute the image recording without causing said recovering means to execute the recovery operation in a case where the total coverage rate of the recording part is not more than said predetermined value.

24. The image recording apparatus according to claim 22, wherein said coverage rate calculating means calculates a coverage rate of a recording part with respect to said each ink color,
said comparing means compares said coverage rate of the recording part with a predetermined value with respect to said each ink color, and
said controlling means causes said recovering means to execute the recovery operation and then said recording means to execute the image recording in a case where said elapsed time exceeds said first predetermined time and said coverage rate of the recording part exceeds said predetermined value, and causes said recording means to execute the image recording without causing said recovering means to execute the recovery operation in a case where said coverage rate of the recording part is not more than said predetermined value, with respect to said each ink color.

25. A method of controlling an image recording apparatus comprising a recording unit ejecting ink from a nozzle to a recording medium to record an image, a recovery unit performing a recovery operation to recover an ejecting condition of said nozzle, a clocking unit measuring an elapsed time from a precious recovery operation by said the recovery unit, and a receiving unit receiving a command to record the image on the recording medium, comprising the steps of:
calculating a coverage rate of a recording part of the image to be recorded by said recording unit;
comparing said elapsed time with a first predetermined time;
comparing said coverage rate of the recording part with a predetermined value; and
causing said recovery unit to execute the recovery operation and then said recording unit to execute the image recording in a case where said elapsed time exceeds said first predetermined time and said coverage rate of the recording part exceeds said predetermined value, and causing said recording unit to execute the image recording without causing said recovery unit to execute the recovery operation in a case where said coverage rate of the recording part is not more than said predetermined value, when the receiving unit receives the command.

26. The method of controlling the image recording apparatus according to claim 25, further comprising the step of causing said recording unit to execute the image recording without causing said recovery unit to execute the recovery operation in a case where said elapsed time is not more than said first predetermined time.

27. The method of controlling the image recording apparatus according to claim 25, further comprising the step of causing said recovery unit to execute the recovery operation and then said recording unit to execute the image recording in a case where said elapsed time exceeds a second predetermined time longer than said first predetermined time when said receiving unit receives said command.

28. The method of controlling the image recording apparatus according to claim 25, wherein a plurality of stages of said first predetermined times are provided and said predetermined value of said coverage rate is provided with respect to each of said plurality of stages of said first predetermined times.

29. The method of controlling the image recording apparatus according to claim 28, further comprising the step of causing said recovery unit to execute the recovery operation and then said recording unit to execute the image recording in a case where said elapsed time exceeds a second predetermined time longer than each of said first predetermined times.

30. The method of controlling the image recording apparatus according to claim 25, wherein said image recording apparatus further comprises a document reading unit reading a document to create image data to be formed by said recording unit, and
the step of calculating a coverage rate of a recording part is performed based on the image data of the document read by said document reading unit.

31. The method of controlling the image recording apparatus according to claim 30, wherein the step of calculating a coverage rate of a recording part is performed, by causing said document reading unit to read the document in a time shorter than an original reading time of said document reading unit, based on the image data of the document read in the shorter time, before said document reading unit reads the document.

32. The method of controlling the image recording apparatus according to claim 25, wherein said image recording apparatus further comprises an obtaining unit obtaining image data to be formed by said recording unit, and
the step of calculating a coverage rate of a recording part is performed based on the image data of the document obtained by said obtaining unit.

33. The method of controlling the image recording apparatus according to claim 25, wherein said recording unit comprises a plurality of nozzles in a line, and
the step of calculating a coverage rate of a recording part is performed based on said image at a part corresponding to an ejected part of a nozzle positioned at an end of said line.

34. The method of controlling the image recording apparatus according to claim 25, wherein said recording unit comprises a plurality of nozzles for each of a plurality of ink colors in a line.

35. The method of controlling the image recording apparatus according to claim 34, wherein
the step of calculating a coverage rate of a recording part is performed by calculating a coverage rate of a recording part with respect to said each ink color and adding the coverage rates of said ink colors,
the step of comparing said coverage rate of the recording part is performed by comparing said total coverage rate of the recording part with a predetermined value, and
the step of causing said recording unit to execute the image recording is performed by causing said recovery unit to execute the recovery operation and then said recording unit to execute the image recording in a case where said elapsed time exceeds said first predetermined time and said total coverage rate of the recording part exceeds said predetermined value, and causing said recording unit to execute the image recording without causing said recovery unit to execute the recovery operation in a case where the total coverage rate of the recording part is not more than said predetermined value.

36. The method of controlling the image recording apparatus according to claim 34, wherein
the step of calculating a coverage rate of a recording part is performed by calculating a coverage rate of a recording part with respect to said each ink color,
the step of comparing said coverage rate of the recording part is performed by comparing said coverage rate of the recording part with a predetermined value with respect to said each ink color, and
the step of causing said recording unit to execute the image recording is performed by causing said recovery unit to execute the recovery operation and then said recording unit to execute the image recording in a case where said elapsed time exceeds said first predetermined time and said coverage rate of the recording part exceeds said predetermined value, and causing said recording unit to execute the image recording without causing said recovery unit to execute the recovery operation in a case where said coverage rate of the recording part is not more than said predetermined value, with respect to said each ink color.
